(19) United States
(12) Patent Application Publication
(10) Pub. No.: US 2004/0060779 A1
(43) Pub. Date: Apr. 1, 2004

(54) Distance compensating shim for clutch/brake and method of determining same

(76) Inventor: Charles Kreger, Cadiz, KY (US)

Correspondence Address: WILLIAM S. LIGHT BODY, ESQ., LIGHTBODY LAW OFFICE, ATRIUM SUITE 100, 32600 FAIRMOUNT BLVD., PEPPER PIKE, OH, 44124, US

(21) Appl. No.: 10/261,124

(22) Filed: Oct. 1, 2002

(51) Int. Cl. F16D 55/36

(52) U.S. Cl. 188/71.5

(57) ABSTRACT

A method of manufacturing a selectively engageable friction mechanism such as a brake assembly including series of adjoining hard anodized brake disks having an accumulation of tolerances, the method including preloading the series of brake disks in order to measure for a shim that compensates for the accumulation of tolerances.

### FIELD TO WHICH THE INVENTION RELATES

This invention relates to a method of manufacturing a selectively engageable friction mechanism for a brake or clutch shaft such as those typically utilized in a combination axle support and brake mechanism, and the mechanisms produced thereby.

### BACKGROUND OF THE INVENTION

Selectively engageable friction devices for shafts have been utilized to control power in a positive mechanism (such as a motor clutch) and/or a negative mechanism (such as a brake). In some instances, the same shaft has been utilized for a secondary purpose, such as functioning as an axle (such as for a wheel) or a rotary support for a secondary member (such as a winch spool).

Certain of these mechanisms include interleaved pairs of disks, each pair connected to differing parts thereof. Typically these disks include concentric sintered rings of a friction substance on the outer surfaces of the disks. This additional substance significantly increases the depth of each disc, as well as the overall length of any device incorporating same.

Prior art disc brake and clutch assemblies also often involve complicated manufacturing and assembly routines. Further the friction mechanisms utilized commonly require multi-step manufacturing techniques. These involved manufacturing requirements greatly increase production and repair costs. In addition to initial assembly issues, the devices also effectively prevent repair of the mechanism in the field. A further problem with these mechanisms is their relative non-uniformity of actuation in the field. Variances of 0.15″ between brakes is not uncommon. Factors causing this can include tolerance build-up between adjoining parts in any individual unit as well as the manufacturing tolerances across a series of units. While these deviances may be acceptable in a resultant device from the standpoint of both a manufacturer and ultimate user's standpoint, a more refined brake would be desirable: while apparently small, brakes built to this standard may differ by thousands of lbs./in in holding power. The invention of this application provides a more refined brake.

One application for brake shafts is as a combined axle and brake mechanism for scissorlifts. However, in addition to the above problems, the cost of the present combination mechanisms are high. Manufacturers of scissorlifts therefore commonly use live axles with separate drum brake mechanisms taken from a small automobile. This type of mechanism is functional, but typically compromises the overall design of the device. The invention of this application relieves this compromise.

### SUMMARY OF THE INVENTION

It is an object of this invention to substantially simplify the manufacture and assembly of parts of a clutch/brake shaft and housing combination;

It is an object of this invention to produce differing reliable repeatable brakes;

It is another object of this invention to reduce associated manufacturing and servicing costs for brakes;

It is a further object of this invention to increase the uniformity of the friction mechanism throughout its service life;

It is another object of this invention to increase the uniformity brakes across an entire product line.

It is a further object of this invention to reduce the number of parts utilized in a service brake;

It is another object of this invention to accurately preset actuation parameters for brakes;

It is yet another object of this invention to facilitate the uniformity of application forces in brake assemblies;

It is still a further object of this invention to compensate for the manufacturing tolerances for brake assemblies;

It is another object of this invention to provide for a brake assembly adaptable to multiple uses;

It is an object of this invention to allow manufacture of a brake with even bolt torque; and,

It is yet another object of this invention to reduce the length of assembly bolts.

Other objects and a more complete understanding of the invention may be had by referring to the drawing in which:

### DESCRIPTION OF THE DRAWINGS

The invention will be described in a preferred brake for a gerotor motor.

FIG. 1 is a representational view of a device for practicing the manufacturing steps of the invention;

FIG. 2 is an enlarged view of the dimensional dial utilized in FIG. 1;

FIG. 3 is listing of the steps used in the manufacturing with the device of FIG. 1;

FIG. 4 is a cross-sectional side view of a spring applied pressure released brake built in accord with the invention in its spring applied condition;

FIG. 5 is a cross-sectional side view of the brake of FIG. 4 with integral motor;

FIG. 6 is a plane view of the disc spring utilized in FIG. 4;

FIG. 7 is a side view of the disc spring utilized in FIG. 4;

FIG. 8 is a plane view of a brake disk used in FIG. 4;

FIG. 9 is a side view of the brake disk of FIG. 8;

FIG. 10 is a plane view of reaction disc of FIG. 4;

FIG. 11 is a side view of the reaction disc of FIG. 10;

FIG. 12 is an enlarged partial view of the brake unit of FIG. 4;

FIG. 13 is a view like FIG. 5 of a brake mechanism incorporating a dual pressure release spring applied actuation mechanism;

FIG. 14 is a view like FIG. 4 with a coil spring actuation mechanism;

FIG. 15 is a force vs. deflection curve for various type springs; and,

FIG. 16 is an enlarged partial view of the bolts holding the endplate to the housing. This fig includes a representational view of the press utilized to manufacture this connection.

### DETAILED DESCRIPTION OF THE INVENTION

The invention of this application relates to a method of manufacturing a device including a multiple part assembly and the device manufactured thereby.

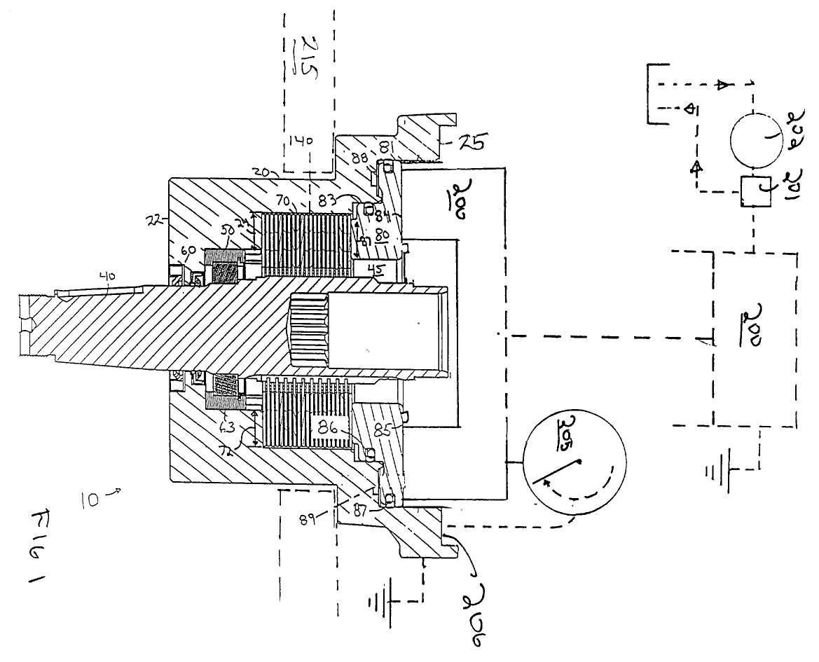

In this invention the parts of the device having an accumulation of tolerances are placed in their relative positions, placed under an artificial loading and then measured (FIGS. 1-3). The manufacturer then compares this measurement with a known standard, selects a proper compensating shim for that particular unique series of parts, and includes this shim with the series of parts in an integral unit prior to the ultimate final assembly thereof.

This manufacturing operation simultaneously compensates for the individual components used in that unit's particular integration of parts as well as providing for a uniformity across an entire series of individual units. The shims thus both simplify manufacture as well as increasing the interchangeability of the various units.

The shims simplify manufacture for reasons including compensating for the tolerances inherent in the manufacturing of individual components (such as brake disks wherein, even if each is within allowed tolerances, there is a resultant brake mechanism having a unique total aggregate geometry). This eliminates the need to hold each individual part to high tolerances and/or the need to measure each of the individual parts. Thus the parts cost less to initially acquire. They also cost less to assemble into the the ultimate device utilizing such parts.

The shims allow interchangeably by allowing the ultimate devices to have repeatable predictable operating qualities (i.e. the fifty-first unit assembled would function the same as the second unit). The shims also allow for accurate setting of the spring biased operation of a given brake with the use of particular, maybe different, shims. This would have the effect of setting that given brake to a known, predictable value due to the use of that value of shim.

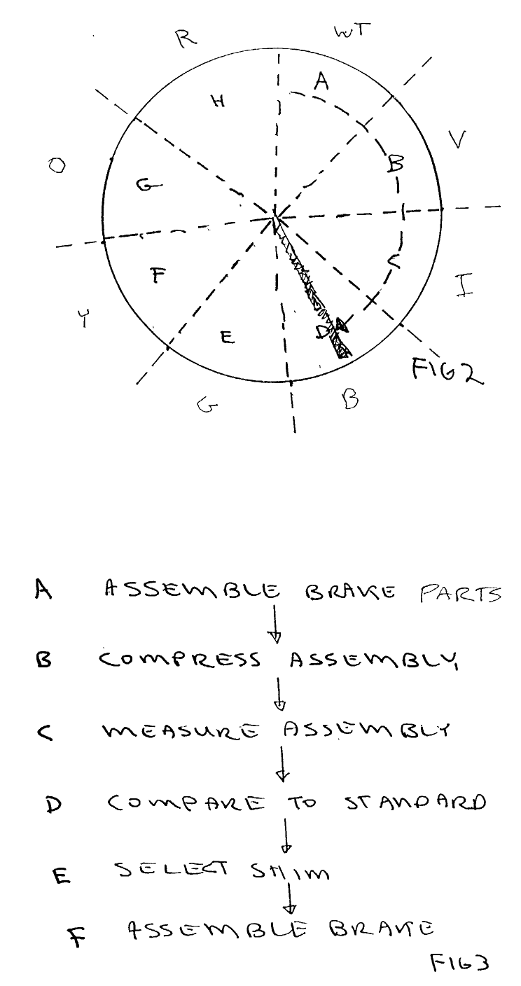

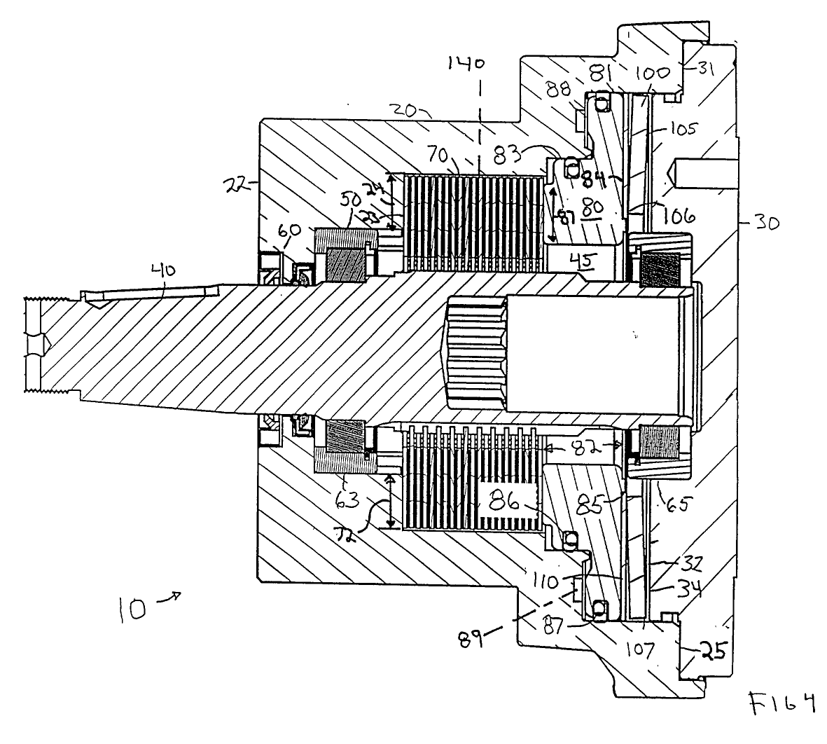

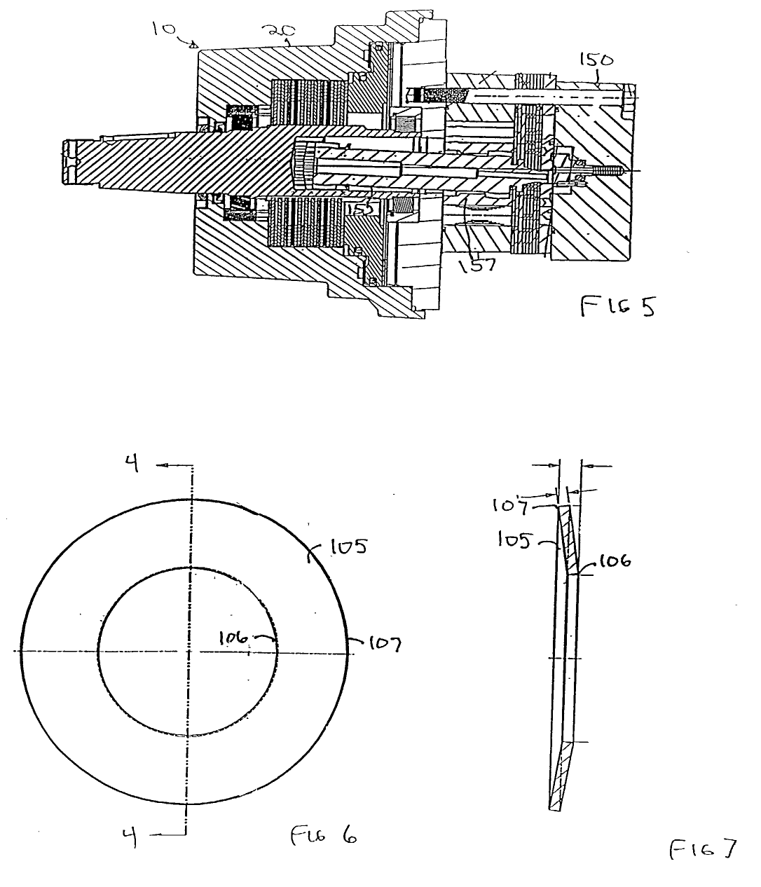

In the preferred embodiment disclosed the units are brake mechanisms having a plurality of consecutive brake disks 70 located adjacent to a spring loaded piston 80 and it is desired to provide a similar level of spring brake bias across the series of completely assembled mechanisms (FIG. 4). To accomplish the invention in this embodiment a brake mechanism 70 is located in its proper position relative to the housing and piston (with end cover 30 off) and a specified load is applied (FIGS. 1-3). After this load application (compression), a total dimension of the brake mechanism is then measured. (The dimension is selected in conjunction with an appreciation of future actuation movements within the device—in this case compression of the brake disks.) A shim is then selected based on this measurement to vary the dimension to a predetermined value. This inherently determines the nature of the tolerance build-up due to the manufacturing of other parts (primarily the brake disks and housing). This selection of a shim to this measurement precisely compensates for the unique geometry of the device by producing a relatively known total stack height for the individual unit. Maintaining the stack height between assemblies produces a brake mechanism which has similar operating properties relative to other brake mechanisms across the series, with the shims ensuring a pre-established geometry regardless of the individual components which may be used in assembling an individual unit. Further to the above the final assembly of an individual unit also optionally incorporates a press to minimize torque variance between bolts. It also can shorten bolt and associated flange length.

To exemplify the invention in the embodiment disclosed a disc spring is being utilized to bias the brake into an engaged mode (the particular brake being spring applied pressure release). As the spring height, and the location of the inner surface of the endplate surface are known, the shim can be selected to provide that unit with a selected braking force (see FIG. 15 for deflection height compression for various spring models). With knowledge of the height room for a given device (by loading it to measure), the manufacturer can utilize the added shims to provide a certain operating quality to a given brake (i.e. 0.25 compression an 8,000 braking force for a high power brake; 0.125 compression for 6,000 braking force; 0.1 to 0.15 for a 5,000-6,500 braking force) (and all with a single disc spring limit). Holding the spring in a tighter range would provide a more precise loading. The shim can thus loosely or more precisely set a given unit to fit a tight individual specification in a controllable operation. Further the shim would allow otherwise overly thick or overly thin springs to be utilized by altering the shim concomitantly (an example of this would be to use soft spring having a pressure of 500 pounds in the unit of FIG. 4 for use as a retarder). The measurement and use of shims allows for many alternative applications for a given device (i.e. an example utilization of a thick shim could increase brake pressure of a given unit to 7,600 pounds at 0.50 from 4,000 pounds at 0.025).

Note that it may be desirable to swap out or otherwise interchange the brake disks or other parts to provide for a more predictable first measurement on the total dimension of the brake mechanism. This would reduce the range of shims necessary to produce a given brake quality. In addition it could provide a different range for a series of brakes (i.e. one 2,000-3,000 lbs./in and 3,000-4,000 lbs./in). In either instance the shims are utilized to provide predictable braking qualities.

The shims perform three functions: 1) compensating for the tolerances inherent within a specific brake unit; 2) allowing a specific brake unit to be manufactured to known operation levels; and, 3) allowing a series of brakes to have the same known operating qualities. The shims also provide a unique solution to wear of the piston by the spring. For example, in the absence of such shims, the edge of the spring might bind into the piston creating over time grooves that reduce the efficienicies and longevity of the brake assembly. In the presence of such shims, no such binding occurs allowing for the bias assembly to interface with the piston without interference. In addition the use of a press in the final assembly provides for more even torque between bolts. It allows faster assembly (due to the elimination of the torque loading on the bolts until final torquing).

The invention begins with a series of parts that, when assembled, have a known or predetermined relationship to each other and to operational surfaces (step A in FIG. 3). In particular, each of these parts in the preferred embodiment has a dimension in respect to a single axis (longitudinal disclosed), which dimensions accumulate to a certain total in respect to the known reference point (an internal flat surface 23 of a brake housing disclosed). While this total is nominally known (for example due to specification on a blueprint), in fact each deviates therefrom if for nothing else than manufacturing tolerance. To build every accumulation of parts to an exact dimension is prohibitory expensive, whether accomplished by exact specification or individual measurement. The accumulation of parts preferably has no resilient components (i.e., springs) in order not to have to compensate for other than linear variables. The accumulation also has as many parts as possible so the final adjustment is not compromised by intermediate variables. In addition, it is desirable not to require a blind measurement during the shim selection process or subsequent final assembly.

In the preferred embodiment of FIG. 1 the accumulation of parts include the interleaved disks 75, 76 and the piston 80. Each of these parts has a depth that is nominally held to a certain dimension. Examples of this depth are 77, 78 and 82 in FIGS. 9, 11 and 12 respectively. While each of these dimensions alone might be individually determinable (for example by measurement), due to the fact that each is plus or minus a certain tolerance in aggregate they accumulate from a practical viewpoint to an unknown value. For example in the device of FIG. 4 there are twenty interleaved brake disks, a piston and a spring between two fixed operational surfaces 23 and 32 (later described). This makes twenty-two total parts, each by itself contributing to the single desired dimension of total depth from the reference point 23. Given that each disc is a stamping with a specification thickness of 0.078-0.082 a total variation of 0.80 is possible due to the disks alone (the piston is ground to 0.913-0.918 specification for a deviation of 0.005). In the preferred embodiment the spring, being a single part having a highly repeatable depth dimension (0.382″ in the embodiment disclosed) is factored out. In addition, the endplate being a single part (also immobile and in the way of measurement) is left off. While this eliminates an operational surface 32, an equivalent reference point can be substituted. This second reference point is preferably relatively fixed in respect to the first reference point 23. In the preferred embodiment a second surface 25 of the housing is utilized. This is possible because the endplate 30 is a solid part fixedly connected to such housing 20 to effectively become a unitary structure. Therefore, by subtracting the known offset depth of the endplate from surface 31 to surface 32 from the distance from the distance from the reference surface 23 to the second reference surface 25 the effective distance between 23 and the now phantom surface 32 is established. The endplate 30 shown is accurately machined to a nominal depth of 0.595 with the distance from 31 to 32 is maintained to be within 0.002″ of that. Note that in the preferred embodiment the first reference surface 23 is itself inaccessible. The reason for this is the location of brake disks 70 and piston 80 within the housing 20. For this reason the reference points for measurement in the preferred embodiment are the open backside 84 of the piston 20 and the surface 25 on which a known but missing component (the endplate 30) will be referenced. By factoring out the spring 100 for reasons previously discussed, this measurement mathematically defines the total stack height in the embodiment disclosed (the former is utilized as being an accessible termination of an accumulation of parts: the latter as being a reliable machined surface of the housing that is referenced itself to the beginning of the accumulation of parts). By comparing this measurement to the known distance between reference points, the size of the shim is determined for that individual unit. By utilizing the shim, this unit will have known operating qualities by itself, and by utilizing shims (albeit differing) in each unit a series of units will have similar operating qualities.

In respect to known operating qualities, in the preferred spring operated pressure released brake the spring 100 will bias the brake with a known force (i.e., deflected a desired distance). The brake can thus be designed for a particular functional level. This allows more predictable design in devices incorporating same. (Note that the spring with different force/distance ratios can be substituted with the same advantage of the device produces has operating qualities x, as will the next one made under the same procedures.)

In respect to similar operating qualities, each individual unit will have a similar deflection irrespective of its particular parts. The units can thus be interchanged with a certain degree of certainty that the new unit will perform the same as the old. Field replacement is thus easy.

In respect to the preferred embodiment the brake disks 70 and the piston 80 are incorporated.

The disks 75, 76 are incorporated because they are the main operatively engageable parts for the device shown. Note in this respect that a spring having lesser or greater resilient properties could be substituted for the particular spring choice. For example if more holding power is desired a stronger spring could be utilized, or multiple springs acting in concert. If less properties are desired a thinner spring or a more resilient spring could be utilized. Given that the opening for the spring is known (by preload measurement, thickness available) for spring action could this be utilized to produce similar units (for unique custom applications). In addition as they the most numerous they will provide the largest aggregate deviance from a known standard.

The piston 80 is incorporated in the measurement for it is utilized as the selectively operable movable member in the brake assembly. It also has critical seals 86, 87 on its outer circumference that could otherwise be compromised during the compensating measurement (the piston 80 also physically protects the inner surfaces of the housing 20 on which these seals will seat). Note that this choice of a termination for the accumulation of parts recognizes other design requirements. For example in that the piston is intermediate the brake application spring 105 it has axial movement clearance to the housing outside of the brake disks; if it did not the brake could not be applied. This attribute assures that loading of the piston would load the brake disks 70. Additional example the spring 105 is the only part intermediate the piston 80 and endplate 30, and it is capable of highly repeatable manufacture (on the order of +0.012″ −0.006″). Omitting it is therefore without significant cost in accuracy while also removing the need for compensation for its resiliency. The inclusion of the piston in the accumulation also compensates for its own dimensional inaccuracies. The shim is thus substantially accurate within the dimensional accuracy of a single part—the endplate.

The housing 20 is included in the measurement for it is the part that retains the operative parts (disks, piston, spring) in position in respect to each other (including the housing also inherently additionally compensates for its own dimensional tolerance factors).

The spring 100 is not included (or factored out) as previously set forth because its typical manufacture provides relatively high repeatable part size. Its non-inclusion also removes part resiliency factors from measurement considerations (the piston and brake disks being relatively non-compressible). If the spring 100 is amenable to initial full prestressing cycles (i.e., pressing it downwards over its state value to flatten it), the spring could be left in place thus combining shim measurement with spring prestressing.

In the preferred embodiment shown the brake disks 75, 76 and piston 80 are assembled into the housing 20 prior to measurement. This is preferred because it automatically factors in deviations in dimensions in the housing (for example surface 23 to 25) as well as providing a convenient container for the packet of separate accumulation parts (disks 75, 76 and piston 80). Note the shim could be measured with an otherwise includable part (such as the piston) in position and included intermediate the parts (such as between the piston and brake disks).

After the selected parts are assembled they are measured (step C in FIG. 3). This measurement involves placing the parts under load and measuring a distance to which the total accumulation of parts can be referenced in order to establish shim sizing. In the spring applied/pressure release embodiment of FIG. 1 the measurement is representative of the distance between the open surface 84 on which the spring rests on the piston 80 and the inner surface 32 of the endplate 30 (represented by surface 25 of the housing as previously set forth). With the spring factored out (due to its known qualities), this measurement would therefore provide a basis for calculation of the preferred shim. (distance minus spring height equals shim size). Note that in the preferred embodiment disclosed the measurement is not taken directly, if for no other reason than the endplate is off. The actual measurement is from the backside 210 of the loading piston 200 and the housing surface 25 on which the endplate 30 will seat. Knowing: a) the relative length 211 of the piston 200; b) the dimension 33 of the endplate between the surface 31 that will seat on the housing and the inner surface 32 of such endplate; and, c) the height of the spring 105 actual shim size (or offset) can be determined.

For example a measurement 200 of the compressed brake disk combination and the seating surface 24 of the piston would provide the dimension necessary to calculate the offset size of the compensating shim.

To facilitate the selection of the appropriate shim it is preferred that the offset size be indicated in a manner easily recognizable by the assembly technician without the necessity of any math or preliminary calculations. In the embodiment disclosed this manner is provided by a circular dial (a micrometer) with sections indicated by size (a-h) and color (white-violet-indigo-blue-green-yellow-orange-red) (FIG. 2). By indexing the shims with corresponding coding (by the box or by the shim) assembly is facilitated. Note that it is further preferred to use lighter colors to denote within acceptable range and darker colors (or a separate warning element such as light, buzzer, etc.) to indicate out of range. The amount of contrast should therefore increase as the colors transverse white to red, preferably abruptly as yellow-orange-red so as to delineate caution.

Once the appropriate compensation shim is selected, it is placed in that particular device. A use of the compensating shim in any particular unit (steps D and E in FIG. 3) provide for a uniform brake despite differing construction/assembly standards.

The final step of manufacturing is to assemble the individual unit with its associated shim (step F in FIG. 3). This would include the parts of such unit that have been omitted (or placed out of order) for the measurement step. In the preferred embodiment disclosed this would include the spring and endplate with the endplate affixed to the remainder of the housing.

Note that this final assembly can also include a press (FIG. 16). This optional assembly method would locate the endplate in position in respect to the remainder of the housing and physically forcing it (against the opposing pressure of the spring) to seat on same. The assembly bolts would them be inserted into corresponding holes in the endplate into threaded holes in the main body of the housing 20 and run in. Due to the fact that the endplate is already seated on the housing very little power would be necessary for running the bolts in. This allows each bolt to have more even torque re: other bolts. In addition the bolts (and housing flange) could be shorter (to the minimum holding necessary to retain the endplate to the rest of the housing during use after assembly). After run in the bolts would receive final torquing and assembly completed. (This would be the only time significant torque would be necessary on the bolts.) Without this intermediate step the bolts would be of a length necessary, and tightened by a torque sufficient, to compress the springs individually. Due to the necessity of torquing each bolt individually torque is uneven—especially between the first and last bolts. Torque difference and length are thus less with the inclusion of a press during final assembly than without.

Thereafter any unit assembled to the same standard can be substituted for this unit providing the same braking performance. This would be true if the unit was an exchange or remanufactured unit. The reason for this is that every brake assembled would have a relatively uniform location for the spring—the main brake operative member; each spring would therefore load the brake disks of its own unit in a manner similar to all other springs, and this would be true no matter what that deviations of that particular unit. The series would thus provide similar braking performance. This is particularly desirable in units with mechanical operation (such as the spring loaded brake disclosed).

In the preferred embodiment of this invention the engagement surfaces of disks in a disc pack is incorporated into an engagement mechanism (FIG. 4).

In the engagement mechanism at least a pair of disks 75, 76 are located adjacent to each other between an engagement mechanism 87 and a reaction surface 24. The two 87, 24 are movable in respect to each other so as to press the disks 75, 76 against each other. Since one disc 75 is drivingly connected to one part 40 while the other disc 76 is connected to another part 20, this action interconnects the two parts 40, 20 to each other. This serves as a clutch is both parts 40, 20 can rotate while serving as a brake if one part 40, 20 is relatively rotationally impeded. For example if part 20 is able to rotate at the same speed as part 40, the engagement action produces a driving connection therewith. This would result in power between 40 and 20. Additional example, if part 20 is fixed, engagement of the disks 75, 76 would retard rotation of part 40, thus producing a braking connection.

In the embodiment disclosed the engagement mechanism 82 is a piston 80 axially moved by fluid pressure through a sealed transfer passage 89 through part 20 into sealed cavity 88. With the utilization of a selective engagement as described between case, sun, planet carrier and/or planetary ring gears of a planetary mechanism, or differing gears in a multi-gear transmission, multi-speed functions can also be provided by this action, manually or automatically as desired by this mechanism. Many multi-speed gearing designs are known in the art.

In the invention of this application the surface of at least one disc 75, 76 is hardened so as to create an integral wear surface. This hardened wear surface infuses into the physical metal of the disc as well as building up the thickness of the disc beyond its pre-hardened surface. Preferably substantially half (30-60% preferred) of this hardening is internal of the pre-hardened surface. This reduces the possibility of flaking and separation while also allowing for efficient heat transfer as is possible in a single thickness disc.

In the embodiment of FIG. 3 the T-6 aluminum 6061 disc has an original thickness of 0.083 with a hard anodized surface addition of 0.0025 “to its finished thickness (with a similar 0.0025 infusion into the anodized disc material)”.

Note that it is not necessary to harden both disks 75, 76. Indeed in the embodiment of FIG. 4 disc 76 is a steel disc covered with black oxide to 1-5 microns per side.

The inclusion of the invention produces a much shorter disc pack than otherwise possible (in contrast for example to a construction incorporating a GEMPCO 473 friction material on both steel disks building the thickness of each disc from 0.072 to 0.133 in the series shown. Even with the GEMPCO material on half the disks the difference is still significant. There is also a significant disparity in costs, with the GEMPCO disks requiring additional manufacturing operations and materials. Further the full overlapping area of the disks 75, 76 is utilized as a friction surface in the invention while the GEMPCO processed disks is limited to the extent of the GEMPCO.

The preferred embodiment of this invention relates to a method of assembly of the brake assembly 10 (FIGS. 1-3) together with the device produced thereby. The brake assembly 10 has a housing 20, a shaft 40, a brake mechanism 70 and a bias assembly 100.

The housing 20 serves to rotatively support the shaft 40 to a main structural member (not shown) as well as providing a location for the brake mechanism 70. The preferred housing 20 shown serves as the main axle for a wheel, winch or other component attached to the shaft, physically transferring substantive forces to the structural member (such as the wheel to frame connection in a scissorlift). The particular housing disclosed is of two-part construction, having a front 22 and an endplate 30 with a cavity 45 between.

The front 22 of the housing 20 has substantially all the machined surfaces formed therein. In the embodiment shown these can be formed from one side thereof. This facilitates the alignment of the machined surfaces. This also reduces the cost of the brake assembly 10 as well as increasing service life. The major concentric surfaces which are machined in the front 22 of the housing shown include the areas surrounding the front bearing 50, the contaminant seal and the oil seals 60 and the two surfaces 81, 83 radially outward of the activating piston 80 for the brake mechanism 70. This machining also provides a reference for the later described manufacturing measurements.

The simplified design of the endplate 30 of the housing largely eliminates previously required machining. In the simplest embodiment, the endplate comprises a plate. Those areas which are machined in this preferred plate include the locations of the rear bearing 65 and the face surface 31 between the front 22 and the endplate 30. Note that it is further preferred that the distance between the face surface 31 and inner surface 34 of the plates be similar if not identical between individual end plates. This allows a manufacturer to factor this dimension out in the later described manufacturing procedure while at the same time providing for a uniformity of operation between such units. This in combination with the novel design of the bias assembly 100 further greatly simplifies manufacturing and assembly of the device (as later described).

In the embodiment disclosed the endplate 30 is connected to the front 22 of the housing by bolts 27. It is preferred that this interconnection also be made in a press (FIG. 16). By using this press 300 to artificially compress the spring 105 and seat the endplate 30 surface 31 on the back surface 24 of the front 22 of the housing 20, it is not necessary for the bolts 27 that will ultimately integrate the housing 20 be individually tightened against whatever spring resistance might be present for that particular bolt at that needed to retain the housing together during ultimate use. Further the bolts 27 can be relatively freely run in with significant power only applied during the final torquing of such bolts 27, thus speeding final assembly time while also lowering assembly effort.

The shaft 40 is rotatively supported to the housing 20 by bearings, a first bearing 63 in the housing front 22 and a second bearing 65 in the endplate 30. In the particular preferred embodiment disclosed bearings 63, 65 are roller bearings (FIG. 4). The inner race of the roller bearings 63, 65 shown are machined directly onto the shaft 40, thus allowing for a stronger bearing and smaller device for a given shaft diameter than possible with a bearing having its own separate inner race.

The oil seal is located directly next to the main bearing 63 in a seal cavity formed in the housing 20. The seal shown is a high pressure seal so as to contain the operative pressure utilized in moving the later described piston 80 in the cavity 45 against the biasing force of the spring 105 (this operating pressure is typically 1000-2000 PSI). An additional contaminant seal is located in a seal cavity formed in the housing 20 substantially next to the oil seal 60 axially outward thereof. This contaminant seal protects the oil seal and neighboring shaft from physical debris such as dirt and water.

The brake mechanism 70 preferably surrounds the shaft 40 located between the two bearings 63 and 65. This allows the bearings to primarily absorb any radial forces on the shaft 40 directly between such shaft to the housing 20. This separates the load bearing function of the shaft from the brake such that the brake mechanism 70 can be completely eliminated without compromising the physical and rotational support between the shaft 40 and housing 20.

The preferred embodiment of the brake assembly is spring activated and hydraulic pressure released (FIG. 4). If desired, an alternate activation mechanism could be utilized such as a pressure applied spring released brake, mechanical activation, and other systems. For example, in an alternate embodiment, the bias assembly 100 may be located on the opposite side of piston 80 from the endplate 30, thus modifying the device to a pressure applied spring released brake. This alternate spring bias assembly thus biases the piston 80 away from the brake mechanism 70, allowing rotation of the shaft 40 in an unpressurized condition.

In the preferred spring applied pressure released embodiment described herein, the bias assembly 100 biases the piston 80 against the brake mechanism 70 to prevent rotation of the shaft 40 in its unpressurized default unactivated condition.

In this preferred spring applied pressure released embodiment disclosed, the bias assembly 100 is located radially outwards of bearing 65. This produces a shorter axial length device than if the bias assembly were to be axially displaced from the bearing 65. Note that in the preferred embodiment the outer race 66 of the bearing 65 also functions as a limit stop for the piston 80 (due to the physical contact of the inner edge 85 of the piston 80 therewith). This limit stop prevents the compression of the disc spring 105 beyond its designed limits. This use of the bearing race as a limit stop also reduces the number of separate parts in the device, simplifying its construction.

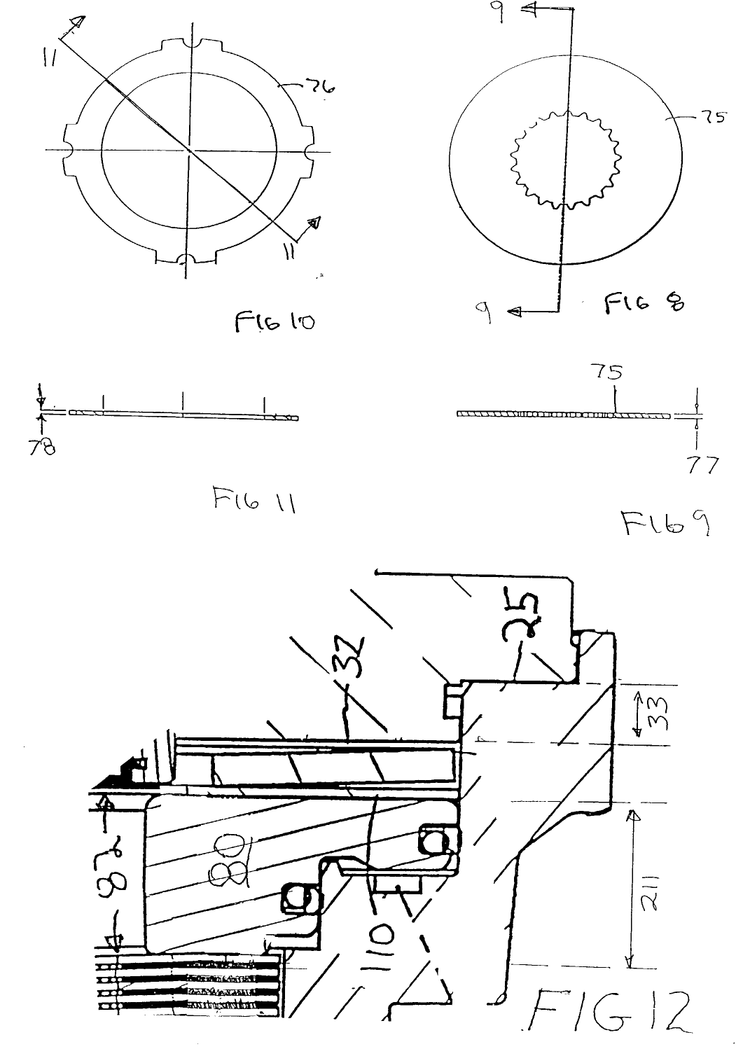

The bias assembly 100 shown consists of a single spring 105 located substantially between the piston 80 and the endplate 30. The spring 105 provides uniform biasing over the entire contact surface of the piston 80 through axial compression of the, surface of the spring. In the most preferred embodiment, the spring 105 is a disc spring. (Note, however, that the measurement and compensation shim 300 invention is applicable to coil springs as well (see U.S. Pat. No. 6,253,882 FIG. 13 and U.S. Pat. No. 6,145,635 FIG. 14). The contents of which are included by reference (in these embodiments the shims 300 would be again located between the spring and piston).

The disc spring 105 of the preferred embodiment replaces the multiple actuation coil springs of prior art devices, thus substantially simplifying and reducing the cost of manufacturing, assembly and repair of the brake assembly 10. Such spring 105 also provides substantial spring pressure in a reduced axial length, allowing for a more compact device. The spring 105 develops its force due to the loading of its inner circumferential edge 106 relative to its outer circumferential edge 107, the former in contact with the piston 80 (through the shim) and latter in contact with the endplate 30. This develops a spring force through a working range from a first load point (the spring 105 compressed against the endplate by the piston 80 due to the pressurization of cavity 88 through a port 89 removing the spring force from the braking mechanism 70) to a second i)ad point (the piston 80 transferring the force from the spring 105 to the brake mechanism 70). In the preferred embodiment of FIG. 4, this provides for an unbraked and braked condition respectively.

The disc spring 105 develops a high spring force with a relatively small deflection in a short length of device. Further, the spring accomplishes this within a limited area while at the same time providing a significant number of cycles within its working range. Note that it is preferred that the inner edge 106 of the spring 100 be substantially aligned within the radial confines 72 of the brake mechanism 70. The radial confines are defined by the overlapping radial areas 24, 87 respectively between the brake mechanism 70 to the front 22 of the housing 20 at one end and brake mechanism 70 to the piston 80 at the other end. This provides for the efficient transfer of application forces axially through the brake mechanism 70.

In the preferred embodiment disclosed, the disc spring 105 is 6 inches in total diameter with an inner diameter of 3.25 inches. The disc spring has an initial height of approximately 0.38 inches and a thickness of approximately 0.19 inches. It has a Youngs modulus of approximately 30,000 KSI with a Poisson ratio of 0.3. It develops a spring force of approximately 5,000 pounds at 0.09 inches deflection to 6,100 pounds at 0.13 inches deflection (with a compressed height of 0.29 to 0.25 respectively example graph shown in FIG. 15). (Note that the spring deflection is small given the tolerances of the brake disks 70 previously described. This embodiment is thus particularly suitable for the invention hereof.) It is cycled up to three times prior to measurements. It has a 1 million cycle life span between load points. The material is a standard cold formed carbon steel. It is manufactured to the group 1, 2 or 3 Din standard 2092/2093 the contents of which are included by reference. (Note that while in the particular embodiment, there is no slotting, such could be included as could rounding of the edges and/or flattening of the load bearing surfaces 106, 107.

In the embodiment disclosed, there is a shim 110 located between the spring 105 and at least one of the piston 80 or the endplate 30. The outer diameter of edge 107 of this shim substantially matches that of the surface 81 while the inner diameter of edge 106 is located between such surface spaced from outer circumference of the bearing 65 (in the embodiment disclosed 5.7 inches).

Shim 110 facilitates the application of forces through the piston 80 from the spring 105 to the brake disks. This provides for a uniformity of forces for an individual brake through the service life thereof, as well as providing for a uniformity between differing brakes. In the embodiment disclosed the torque output of the brake changes substantially 157 lbs./in for every 0.001 of spring deflection. With a total shimmed variation of perhaps 0.005″, the brakes would be similar to within 780 lbs./in. The old shimless tolerance range of 0.025 would produce brakes similar to within the 3,925 lbs./in. Holding higher shim dimensions would produce brakes with less deviation and do so easier and cheaper. The fact that there is a shim intermediate the spring 105 allows the spring 105 to float slightly relative to the piston 80. This facilitates the actuation of the brake. Note that in addition in the absence of such shim 110 the edge(s) of the spring 105 might over time abrade against the piston 80 or the endplate 30. This could effect performance uniformity over time. It could also create grooves over time which would reduce the efficiency and longevity of the brake assembly 70.

In respect to the uniformity forces for an individual unit, each brake is designed for a given braking force (resistance to rotation of the shaft 40 to the housing 20). This force is due to the transfer of spring force from the spring 100 through the piston 80 to the brake mechanism 70. With a knowledge of the distance between the inner surface 34 of the endplate 30 and the adjoining surface 84 of the piston 80 (with the brake mechanism 70 is a compressed state) and the depth of the spring 105 (in its brake actuating position extended position) the depth of the shim 110 for and individual unit can be calculated by the difference. This allows an individual brake unit to be designed for a specific level of braking performance. Further the unit will maintain this performance over time.

In respect to the uniformity between differing brakes, since each individual unit 10 has its own compensating shim 110 and is set for a certain braking force from the spring 105, units across a series can be set to the same braking force (if desired). This allows for a manufacturer to maintain braking forces uniformly, allowing individual units to be exchanged without compromise to performance. This also provides for the use of parts (other than the compensating shim) across a stories of brakes, facilitating the construction and maintenance of the brakes. Note also that adjusting the compression of the spring 105 one could provide 500-7,000 pounds of force from a single spring in a single device by using differing shims.

The actual depth of this shim 110 is developed during the assembly of each individual device as previously set forth (FIGS. 1-3). The reason for this is that while the individual disc springs 105 are manufactured repeatedly in high quantities with close tolerances, the dimensions of the brake mechanism 70 and the piston 80 (together with the relative thickness of the endplate 30 from the surface 31 to the surface 32) may provide stacking tolerances which provide for an uneven application of force in individual units over a production run of brakes incorporating the invention. To accommodate for this the brake mechanism 10 is assembled including its brake mechanism 70 and its piston 80. The partially assembled device is then located in a press and suitably secured (by a collar 215 to the brakes machined mounting flange shown). At this time the piston 80 is loaded by a press to its design application force, in the present example 5,000 PSI by piston 200. The piston 200 is itself pressurized through a valve 201 pressurized by a pump 202. The parameters of the piston 200 are selected to be within the operating parameters of the actuation device (spring 100—the brake is spring operated). Note that in the preferred embodiment the piston 200 is cylindrical. It is therefore unnecessary to locate the brake in any given rotational indexed position in respect thereto. This facilitates production. (Due to differences in shape and size of brake shafts, their use, while possible, is not preferred.)

Upon the valve 205 reaching a certain selected operational perimeter the valve is shut in order to allow the measurement indicating apparatus to settle, thereafter the distance between two references are measured. By references it is meant two differing points that have a relation to one another that is useful in determining the dimension(s) of the compensating shim 100.

In the specific example of FIG. 1 the dimension is measured between the back of the piston 200 and machined location 206 on the housing 20. As the distance between the face 23 and back surface 24 of the former is known, and the distance between the location 206 and the surface 23 of the part assembly known, the dimensions of the entire stack can be calculated (84-23 vs. design distance equals size shim). In this respect it is noted that it is preferred that the shim 100 always be a positive valve greater than the physical breakdown properties of the shim itself. This is reflected in FIG. 2. In specific it is preferred that the stack of parts require a shim large enough so as to not compromise performance during operation while maintaining operation over time. For example area A in FIG. 2 might be such that it indicates that a shim should not be added. It would not provide reliable long term operation at known values. However, later areas would provide such operation via shims.

In the example shown the areas are shaded via the white-violet-indigo-blue-green-yellow-orange-red sequence (area A is within basic tolerance so no shim is added). In the other areas the assembly person adds an appropriate color shim into the unit and then sends it to final assembly. Due to this section of properly dimensioned shims, ever subsequent unit will have similar operating coefficients (i.e., the shims would provide similar or known operating characteristics for all brake units).

Note that it is not necessary that all areas of the indication device cover uniform areas. For example area A may be underrange and area H overrange indicating immediate return of the unit to manufacturing (to provide consistent performance). Similarly areas C-F may be smaller dimensioned units than the others (with the idea that these units would be the norms for conventionally manufactured units, needing only a set range of compensation to meet the selected ranges of operation).

At this time the distance between the outer surface 84 of the piston and the inner surface 25 of the housing 20 (and thus inferentially the plane 32 of the endplate since it is of a known depth) is measured. Given the known geometry of the shim this measurement provides the combined desired thickness of the shim 110. The load is then removed and the shim 110 is selected to precisely compensate for the unique geometry of this particular unit (the load may be cycled a few times to insure no contaminants effect the readings). At this time the spring disc 105 is inserted and the endplate 30 attached to the housing 20 to complete the brake mechanism.

During assembly the endplate 30 is seated on the front 22 of the housing 20 by a press 300 (FIG. 16). This could be accomplished in the same press as measurement. In the embodiment disclosed the press 300 shifts the endplate 30 and front 22 of the housing to force the surface 31 and back surface 24 into physical contact against the resistance of the spring 105 (i.e. the spring 105 is compressed). With the holes 35 in the endplate 30 aligned with tapped bores 28 in the front 22 of the housing 20 (alignment can be accomplished by preliminary aliginment tool between the same or a separate dedicated alignment stud from either). When the endplate 30 is in position, the bolts 27 are run into the holes 35 into the tapped bores 28. This can be accomplished without significant power on any particular bolt due to the removal of the function of drawing down the endplate 30 against the resistance of the spring 105 from this part of the assembly. By eliminating the drawdown function from the bolts 27, each individual bolt would be engaged by substantially the same torque as all of the other bolts. This provides for an even holding power across the full diameter of the endplate 30—no one bolt was taken down unevenly due to the resistance of the spring. Further both the bolt 27 and the tapped bore 28 can be shorter than otherwise due to the same factor: it is only necessary that they engage each other with significant holding power when the pressure of the press 300 is removed—i.e. full depth engagement when the final torquing of the bolt 27 has occurred.

In the embodiment disclosed the bolts 27 are ⅜″×16 and 1¼″ long under the head. This length is longer than needed in a device incorporating the invention in order to allow field disassembly. Further it allows for different shims to be included in the brake to develop differing holding power without consideration of bolt length.

The invention provides for a brake mechanism 10 that has a spring 105 which can be used interchangeably with any brake mechanism, with the shim 110 ensuring a fit and uniform consistent operation irregardless of the individual components utilized in this particular brake, or different holding power between otherwise identical brakes of a single design.

Note that an important element of the shim 110 is to compensate for a particular units unique geometry. The shim 110 itself can be located between the spring 105 and piston 80 (as shown), the spring 105 and endplate 30, or even to offset the endplate (between the surface 25 of the housing 20 and the surface 31 of the endplate 30). (Surface 23 on the inside of the housing is not preferred because it necessitates device disassembly.)

Further under certain limited circumstances the brake disk pack 70 may need augmentation prior to the measurement of shims. This would occur, for example, when the total distance measured was somewhat outside of the operating parameters for the spring 105, if one or two of the brake disks had been accidentally omitted or other inaccuracy occurred. At this time a secondary member would be incorporated in addition to the shim 110. This secondary member would preferably be included on the inside of the piston 80. This to provide for uniformity on the calculation/dimension of shims and to physically distinguish such additional shim devices. A location on either side of the piston or spring would function well.

The spring 105 is capable of highly repeatable manufacture (on the order of 0.012″ to 0.006″). The piston is manufactured having a deviance 0.002″ to 0.005″, and the endplate with +/−0.002″.

It is preferred that the shim 110 be located between the spring 105 and the piston 80. The reason is that here it performs two functions: to allow compensation for the tolerances within the brake mechanism as well as to provide a unique solution for freeing movement and preventing the wear of the piston 80 by the spring 105. (In the absence of the shim 110, the edge of the spring 107 may bind against the piston 80 creating small grooves that would reduce the efficient longevity of the brake assembly.) (In the presence of such shims, no such binding occurs allowing for the bias assembly 100 to inface with the piston 80 without hindrance.) It is also easy to assemble (i.e., drop in shim, spring, and bolt on the endplate).

Note that in the event that the device is used as a combined motor brake mechanism (such as in FIG. 5), it is preferred that the brake mechanism 10 be production assembled in its entirety with a certain endplate, with the brake mechanism then shipped in its assembled condition to a separate assembly line for conversion. The preferred conversion technique removes the endplate 30, machines it to accommodate the motor, and then reassembles the unit to provide for an integrated motor/brake mechanism. This reduces unit to unit deviances while also recognizing the fact that a combined motor/brake would have a lower production volume than a brake alone.

The rotation of the shaft 40 in the preferred embodiment is selectively prevented by the force of the spring disc 105 on the piston 80, which in turn contacts the brake mechanism comprising a set of brake disks 75, 76. These disks 75, 76 are interleaved alternating disks interconnected to the shaft 40 or the housing 20, respectively.

The friction disks 75 are non-rotatively connected to the shaft 40.

In the present design White friction disc, the brake disk is steel with GEMPCO 473 friction material lining on its inner and outer sides, each lining being approximately 0.03 inches thick. This sintered bronze lining material is expensive and in addition complicates the manufacturing and assembly process of the device.

In the brake disk of the present invention, the friction disks are made of a single thickness material having a hard surface. In the preferred embodiment this hard surface is provided by having the material hard anodized. The hard surface could alternately be providing by a coating, such as a hardening material. This provides for a very hard brake disk having a single thickness throughout. In the preferred embodiment such friction disks 75 are constructed of hard anodized metal, most preferably aluminum. Such treatment provides high hardness and wear resistance (comparable to that of steel), shock resistance and strength as well as high flexibility and fatigue strength. This reduces the manufacturing cost of the friction disks 75 by an order of magnitude without: sacrificing performance or longevity of the brake mechanism 70.

In the preferred embodiment disclosed, the disks are 4.0 inches in diameter and 0.078 to 0.082 inches thick and is constructed of T6 aluminum anodic hard anodized coating to Mil-Spec Mil-A-8625 type III class 1 or equivalent spec to a thickness on each side of 0.002+/−0.001 with the majority of saturation of 0.001. The contents of this Mil-Spec is incorporated by reference. The inner edge is grooved to match outer ridges on the shaft 40 thereby to connect to same for common rotation. The specific coating employed by the preferred alternate coating embodiment described is Keronite registered by Isle Coat Ltd., UK. This coating is a complex oxide ceramic produced by surface oxidation electrolysis on the aluminum.

Interleaved with the friction disks 75 are a series of reaction disks 76. By interleaved, it is intended that the friction and reaction disks alternatingly overlap (FIG. 1). The reaction disks 76 are interconnected with the housing 20 in a non-rotative manner. The number of reaction disks is preferably substantially the same as the number of friction disks. One different or multiple non-adjoining series (ABBABBA, ABBAABA, etc.) could also be utilized if appropriate or desired for a given application. Since any rotation of the reaction disks 76 in respect to the housing 20 would allow for some lash, it is preferred that the reaction disks 76 are supported solidly to the housing. Methods of connection employed may include but are not limited to pins, tabs and grooves, etc.

The particular reaction disc 76 is 4 inches in diameter with a series of 4 mounting tabs extending to a 4.3 inch diameter therefrom at approximately 90° intervals. It has an inner diameter of 3 inches and a black oxide coating 1-5 microns per side.

Upon selective interconnection of a port 89 to a source of high pressure, preferably via a valve of some nature, cavity 88 is pressurized, thus overcoming the force of the bias assembly 100 so as to release the brake (in FIG. 4) or applying it (as in FIG. 12). Two seals, 86, 87 located between the piston 80 and the housing 20 retain the pressure in the activation cavity, thus allowing for the activation of the piston 80.

The particular brake mechanism 70 disclosed in this application is a “wet” brake. By this it is meant that the cavity 25 containing the brake mechanism contains hydraulic fluid, albeit substantially unpressurized. This cools the brake mechanism in addition to facilitating the removal of the residue of the friction material which is inevitable in any braking operation. In the preferred embodiment, the oil seal 60 is located in the housing 20 in sealing contact with shaft 40 to prevent loss of lubricant.

Preferably, there is a connection 140 provided to an overflow mechanism to allow for breathing of the fluid in the cavity in addition to allowing for the release of any pressurized fluid which might leak from the cavity 88 into the center 45 of the device surrounding the shaft and brake mechanism 70. This interconnection also allows for the fluid fluctuation which is inherent in the device upon the movement of the piston 80 in the routine operation of the device.

The interconnection between the cavity 45 and the overflow mechanism is not critical. This may be provided by a hole 140 surrounding the brake disks, a hole in the endplate 30, or other appropriate mechanism.

In an alternate embodiment, the shaft 40 may be splined and connected to a drive mechanism 150 (FIG. 5). Examples include a unit wherein the inside opening in the drive shaft 40 would be splined and the endplate 30 replaced by hydraulic power unit 150, an electric motor, or other power unit connected to such splines. It is preferred that such drive mechanism be hydraulic in nature, such as the White Hydraulics, Inc. models RS, RE or DT, TRW M series, Eaton, or Parker Hannifin motors.

In such pressurized embodiment, the wobble stick 155 is connected to the shaft 40 and the orbiting rotor 157. Such wobble stick 155 compensates for the relative displacement between the axis of shaft 40 and the axis of the orbiting rotor 157. Note in the preferred embodiment the pressure of the gerotor mechanism 150 is isolated from that of the brake 10 (by the closed center construction of the motor such as that in U.S. Pat. No. 4,877,383 entitled Device Having Sealed Control Opening, U.S. Pat. No. 5,135,369 entitled Seal Piston, U.S. Pat. No. 6,257,853 B1 entitled Hydraulic Motor, and U.S. Pat. No. 6,074,188 entitled Multi-Plate Hydraulic Motor Valve, the contents of which are incorporated by reference). This is preferred so as to fluidically isolate the two. A combined design could also be utilized such as that in U.S. Pat. No. 3,452,680 entitled Hydraulic Motor Pump Assembly, the contents of which are incorporated by reference. (Operation of open center hydraulic motors would result in pressurization of the inner chambers of the brake assembly 10, including the cavity 45 containing brake mechanism 70. Such pressurized embodiment open seal embodiment would require oil seal 60 to be selected as a high pressure seal.)

Cavity 88 could be internally and or externally connected to the one port of the hydraulic motor 150 to allow selective pressurization of the cavity 88. (Directly or through a separate valve. Note that no valves are necessary between the cavity 88 and the port of the hydraulic motor 150.) Due to this optional interconnection, activation of the motor 150 in this specific embodiment would necessarily pressurize cavity 88, move piston 80, and release the brake (note such embodiment, however, is not preferred as wear of brake disks 75, 76 creates contaminants). Dual chambers behind the piston would provide for two port actuation of the brake (see FIG. 13 for example).

Therefore, although the invention has been described in its preferred forms with a certain degree of particularity, it is to be understood that changes can be made deviating from the invention as hereinafter claimed. For example, although the device disclosed utilizes anodized aluminum friction disks 75, and a disc spring it would be possible to combine with conventional components so as to provide for a good measure of the included invention. Another example, two or more washers could be utilized in order to eliminate potential interaction between the rotatively and axially moving components of the brake mechanism and that of the axially moving piston 80 and spring 105 if desired. In addition steps can be combined. For example, the disc spring 105 is typically cycled prior to measurements thereof. By cycling such disc to its maximum designed loading while in the accumulation of parts everything but the endplate dimension 33 would be included by measurement. For additional example, although the preferred embodiment described herein is characterized as a brake mechanism, the involved technology is also applicable to other selectively engageable friction devices, such as clutches. Last example, the shim size can be determined without the piston in place.

Additional examples of the invention are disclosed in FIGS. 13-14.

FIG. 13 is a coil spring dual actuation device. The basic device is set forth in U.S. Pat. No. 6,170,616 (the contents of which are incorporated by reference). In this device, the piston 120 would be compressed to a certain compression force and the dimensions of the cavity containing spring 111 measured (again by the use of the piston and a housing service. A shim 300 would then be added to compensate for any dimensional differences in the brake stack as to maintain that compression force after assembly (the choice of compression is at the discretion of the manufacturer).

FIG. 14 is a coil spring device with a shim compensating for its dimension in a manner similar to FIGS. 1-6 herein. The device itself without compensation is disclosed in U.S. Pat. No. 6,145,635. The inclusion of measurement and shim 300 in the basic device provides a uniformity for a production standard as well as between devices not present in the current art.

Note that a unit is not restricted to the same parts/parameters of other units. With the measurement of the total stack known, and the location of the reaction surface 34 known, it is a relatively simple manner to consult a force/distance chart to select components to produce a unit with known spring pressures (for example a spring loaded by 0.25″ will have a 7,600 pound force; the same spring loaded by 0.30 would have a 1,600 pound force). The section of differing materials, and differing sizes would thus allow a great number of operating parameters from a single unit, this in addition to repeating the same parameters in a unit of a series of units.

Other modifications can also be made without deviating from the invention as hereinafter claimed.

What is claimed is:

1. An improvement for a method for manufacturing a device having an intermediate assembly stage with a series of non-fixed adjacent components located in a housing,
the method including locating the housing in a tool having the ability to preload the adjacent components in respect to each other,
preloading the adjacent components to a predetermined loading, measuring a distance relative to a dimension of the preloaded adjacent components, comparing said distance to a standard to ascertain the size of a compensation shim, installing said compensating shim in respect to the adjacent components and thereafter completing assembly of the device.

2. The method of claim 1 characterized by the addition of locating a moveable piston of top of the series of adjacent components prior to preloading.

3. The method of claim 1 characterized by the addition of said tool being a hydraulic ram and the additional step of allowing the adjacent components to settle prior to measuring said distance.

4. The method of claim 1 wherein the device has a resilient component and characterized in that said thereafter completing assembly of the device includes location of the resilient component.

5. The method of claim 1 characterized in that the adjacent components are located in the housing of the device neighboring a reaction surface and said measuring the distance relative to the top of the adjacent components includes consideration of the designed distance between such top and the reaction surface.

6. The method of claim 5 characterized in that said measuring the distance relative to the top of the adjacent components includes a coordination surface of the housing.

7. The method of claim 1 characterized in that said measuring the distance relative to the top of the adjacent components includes a coordination surface of the housing.

8. The method of claim 7 characterized in that said tool is a hydraulic ram, said hydraulic ram having a back surface and said measuring the distance relative to the top includes the back surface of said tool.

9. The method of claim 1 characterized in that the adjacent components include a multiplicity of brake discs.

10. The method of claim 1 characterized in that a piston defines the top of the adjacent components.

11. The method of claim 6 characterized in that a piston defines the top of the adjacent components.

12. The method of claim 7 characterized in that said thereafter completing assembly includes locating a spring above the top of the adjacent components and biasing same by closing the housing with an endplate.

13. The method of claim 12 characterized in that said locating a spring includes multiple circumferentially spaced components.

14. The method of claim 1 characterized by a spring opposing said preloading and said predetermined preload being greater that the opposing force of said spring.

15. An improvement for a method for manufacturing a series of individual devices each having an intermediate assembly stage with a series of non-fixed adjacent components located in a housing,
the method including locating the housing of a particular individual device in a tool having the ability to preload the adjacent components in respect to each other,
preloading the adjacent components to a predetermined loading, measuring a distance relative to a dimension of the preloaded adjacent components, comparing said distance to a standard which is uniform for the series of devices to ascertain the size of a compensation shim for that particular individual device, installing said compensating shim in respect to the adjacent components in that particular individual device and thereafter completing assembly of the particular individual device so as to provide uniformity across the series of devices.

16. The method of claim 15 characterized by the addition of said tool being a hydraulic ram and the additional step of allowing the adjacent components to settle prior to measuring said distance.

17. The method of claim 15 wherein the device has a resilient component and characterized in that said thereafter completing assembly of the particular individual device includes location of the resilient component.

18. The method of claim 15 characterized in that the adjacent components are located in the housing of the particular individual device neighboring a reaction surface and said measuring the distance relative to the top of the adjacent components includes consideration of the designed distance between such top and the reaction surface.

19. The method of claim 18 characterized in that said measuring the distance relative to the top of the adjacent components includes a coordination surface of the housing.

20. The method of claim 15 characterized in that said measuring the distance relative to the top of the adjacent components includes a coordination surface of the housing.

21. The method of claim 20 characterized in that said tool is a hydraulic ram, said hydraulic ram having a back surface and said measuring the distance relative to the top includes the back surface of said tool.

22. An improvement for a method for manufacturing a device having an intermediate assembly stage with a series of non-fixed adjacent components located in a housing, the device having a desired level of operation,
the method including locating the housing in a tool having the ability to preload the adjacent components in respect to each other,
preloading the adjacent components to a predetermined loading, measuring a distance relative to a dimension of the preloaded adjacent components, comparing said distance to a series of standards to select the size of a compensation shim appropriate for the desired level of operation, installing said compensating shin in respect to the adjacent components and thereafter completing assembly of the device.

23. The method of claim 22 characterized by the addition of said tool being a hydraulic ram and the additional step of allowing the adjacent components to settle prior to measuring said distance.

24. The method of claim 22 wherein the device has a resilient component and characterized in that said thereafter completing assembly of the device includes location of the resilient component.

25. The method of claim 22 characterized in that the adjacent components are located in the housing of the device neighboring a reaction surface and said measuring the distance relative to the top of the adjacent components includes consideration of the designed distance between such top and the reaction surface.

26. The method of claim 25 characterized in that said measuring the distance relative to the top of the adjacent components includes a coordination surface of the housing.

27. The method of claim 22 characterized in that said measuring the distance relative to the top of the adjacent components includes a coordination surface of the housing.

28. A compensation part for an engagement mechanism having a multiplicity of parts having a compaction distance and a design distance, the improvement of including a shim in the accumulation of parts, which shim has a thickness substantially equal to the difference between said compaction distance and said design distance to compensate for such difference.

29. The compensation part of claim 28 characterized in that a series of differing shims are utilized in a series of engagement mechanisms, which shim individual compensates for the difference between said compaction distance and said design distance in that particular unit.

30. The compensation part of claim 28 characterized in that accumulation of parts includes a piston at the substantial end thereof.

31. The compensation part of claim 30 characterized by the addition of a further compensating part located between said piston and said accumulation of parts.

32. The compensation part of claim 30 characterized in that said compensation shim is on the opposite side of said piston from said accumulation of parts.

33. The compensation part of claim 30 characterized in that said compensation part is on the same side of said piston from said accumulation of parts.

34. A compensation part for a series of individual engagement mechanisms, each individual engagement mechanism having a multiplicity of parts having a compaction distance, there also being a design distance for the series of individual engagement mechanisms, the improvement of including a shim in the accumulation of parts of each particular individual engagement mechanism, which shim has a thickness substantially equal to the difference between said compaction distance for said particular engagement mechanism and said design distance for the series of individual engagement mechanisms to compensate for such difference to provide for uniformity across the series of mechanisms.

35. The compensation part of claim 34 characterized in that accumulation of parts includes a piston at the substantial end thereof.

36. The compensation part of claim 35 characterized by the addition of a further compensating part located between said piston and said accumulation of parts.

37. The compensation part of claim 35 characterized in that said compensation shim is on the opposite side of said piston from said accumulation of parts.

38. A compensation part for an engagement mechanism having a multiplicity of parts having a compaction distance and a known design distance for a given desired level of operation, which level may vary, the improvement of including a shim in the accumulation of parts, which shim has a thickness substantially equal to the difference between said compaction distance and said known design distance to provide for the given desired level of operation.

39. The compensation part of claim 38 characterized in that a series of differing shims are utilized in a series of engagement mechanisms, which shim individual compensates for the difference between said compaction distance and said known design distance for the given desired level of operation for that particular unit.

40. The compensation part of claim 38 characterized in that accumulation of parts includes a piston at the substantial end thereof.

41. The compensation part of claim 40 characterized in that said compensation shim is on the opposite side of said piston from said accumulation of parts.

42. An improvement for a method for manufacturing a brake having an intermediate assembly stage with a series of flat brake disks located in a housing with a reaction surface,
the method including locating the housing in a tool having the ability to preload the top of the brake disks towards the reaction surface,
preloading the brake disks to a predetermined loading, measuring a distance relative to the top of the brake disks and the reaction surface, comparing said distance to a standard to ascertain the size of a compensation shim, installing said compensating shim in respect to the brake disks and thereafter completing assembly of the brake.

43. The method of claim 42 characterized by the addition of locating a moveable piston of top of the series of brake disks prior to preloading.

44. The method of claim 42 characterized by the addition of said tool being a hydraulic ram and the additional step of allowing the brake disks to settle prior to measuring said distance.

45. The method of claim 42 wherein the brake has a resilient component and characterized in that said thereafter completing assembly of the brake includes location of the resilient component.

46. The method of claim 42 characterized in that said measuring the distance relative to the top of the brake disks includes consideration of the designed distance between such top and the reaction surface.

47. The method of claim 46 characterized in that said measuring the distance relative to the top of the brake disks includes a coordination surface of the housing.

48. The method of claim 42 characterized in that said measuring the distance relative to the top of the brake disks includes a coordination surface of the housing.

49. The method of claim 48 characterized in that said tool is a hydraulic ram, said hydraulic ram having a back surface and said measuring the distance relative to the top includes the back surface of said tool.

50. The method of claim 4221 characterized in that there are no resilient components to be preloaded prior to measurement.

51. The method of claim 42 characterized in that a piston defines the top of the brake disks.

52. The method of claim 47 characterized in that a piston defines the top of the brake disks.

53. The method of claim 48 characterized in that said thereafter completing assembly includes locating a spring above the top of the brake disks and biasing same by closing the housing with an endplate.

54. The method of claim 53 characterized in that said locating a spring includes multiple circumferentially spaced components.

55. The method of claim 42 characterized by a spring opposing said preloading and said predetermined preload being greater than the opposing force of said spring.

56. The method of claim 42 characterized in that the standard is determined to provide uniformity across an entire series of individual brakes.

57. The method of claim 42 characterized in that the standard is determined to provide a specific operating level to a given individual brake.

58. An improvement for a method for manufacturing a brake having an intermediate assembly stage with a series of adjacent flat brake disks located in a housing cavity between a movable piston and a housing reaction surface,
the method including locating the housing in a preload tool having the ability to preload the piston towards the reaction surface,
preloading the piston and brake disks between the preload tool and reaction surface to a predetermined loading, measuring a distance relative to the piston and the reaction surface, comparing said distance to a standard to ascertain the size of a compensation shim, installing said compensating shim in respect to the piston and thereafter completing assembly of the brake.

59. The method of claim 58 wherein the brake has a resilient component and characterized in that said thereafter completing assembly of the brake includes location of the resilient component on the opposite side of the piston from the brake discs between the piston and a housing cavity end cover.

60. The method of claim 58 characterized in that said measuring the distance relative to the top of the brake disks includes consideration of the designed distance between such top and the reaction surface.

61. The method of claim 58 characterized in that said measuring the distance relative to the piston includes a coordination surface of the housing.

62. The method of claim 61 characterized in that said tool is a hydraulic ram, said hydraulic ram having a back surface and said measuring the distance relative to the piston includes the back surface of said tool.

63. The method of claim 58 characterized in that the standard is determined to provide uniformity across an entire series of individual brakes.

64. The method of claim 58 characterized in that the standard is determined to provide a specific operating level to a given individual brake.

65. A compensation part for an engagement mechanism having brake discs and an adjacent piston in an accumulation of parts having a compaction distance and a design distance in respect to a reaction surface of a housing cavity containing same,
the improvement of including a shim in the accumulation of parts on the opposite side of the piston from the brake discs, which shim has a thickness substantially equal to the difference between said compaction distance and said design distance to compensate for such.

66. The compensation part of claim 65 characterized in that a series of differing shims are utilized in a series of engagement mechanisms, which shim individually compensates for the difference between said compaction distance and said design distance in that particular unit.

67. The compensation part of claim 65 characterized in that the design distance is uniform across an entire series of individual brakes.

68. The compensating part of claim 65 characterized in that the design distance is determined to provide a specific operating level to a given individual brake.

69. An engagement mechanism, said engagement mechanism having interleaved brake discs and an adjacent piston in an accumulation of parts in a housing surrounding a driveshaft,
said accumulation of parts having a compaction distance in respect to a reaction surface of the housing cavity containing same,
a shim, said shim being in the accumulation of parts on the opposite side of the piston from the brake discs and the reaction surface of the housing cavity, which shim has a thickness substantially equal to the difference between said compaction distance and a design distance to compensate for variances in such compaction distance.

70. The engagement mechanism of claim 69 characterized by the addition of a housing cavity endplate and a spring, and said spring extending between the endplate and said shim.

71. The engagement mechanism of claim 70 characterized in that there are multiple springs.

72. The engagement mechanism of claim 69 characterized by the addition of a housing cavity endplate and a spring and said shim being located between the spring and said endplate.

73. A shim for an engagement mechanism, said shim having a size and said size being color coded.

74. A method of measurement of a quality of a shim, said measurement including an indicator and said indicator having a color to represent the quality of the shim.
